(19) United States
(12) Patent Application Publication
(10) Pub. No.: US 2006/0136400 A1
(43) Pub. Date: Jun. 22, 2006

(54) Textual search and retrieval systems and methods

(76) Inventor: Keith L. Marr, Daly City, CA (US)

Correspondence Address: KIRKPATRICK & LOCKHART NICHOLSON GRAHAM LLP, 535 SMITHFIELD STREET, PITTSBURGH, PA, 15222, US

(21) Appl. No.: 11/288,776

(22) Filed: Nov. 29, 2005

Related U.S. Application Data
(60) Provisional application No. 60/634,029, filed on Dec. 7, 2004.

(51) Int. Cl. G06F 17/30

(52) U.S. Cl. 707/3

(57) ABSTRACT

A method of retrieving information. The method includes obtaining a list of network sites, obtaining a list of key words to be searched for, and retrieving data from the network sites. The method also includes analyzing the data for an occurrence of any of the key words and extracting textual data from the data when a key word is found. The method further includes storing the extracted textual data in a local storage device and formatting the extracted textual data for later analysis and display.

### CROSS REFERENCE TO RELATED APPLICATION

The present application claims priority to U.S. Provisional Patent Application No. 60/634,029 filed Dec. 7, 2004.

### BACKGROUND

Current methods of accessing data from the Internet using a web browser are often time consuming and error prone. A user may access an Internet page through a web browser, but the user must then read all the text on the page in order to know if it contains key words which are relevant to the user. Optionally, a user may, for each page and for each key word, use the browser's “Find” button to manually search for key words within the displayed page. If a user finds a relevant key word on the page, the user may bookmark the page for later retrieval, with the possibility that the content of the page will have changed in the meantime. Optionally, the user may choose to store the page locally on the user's computer, leading to difficulties in organizing and sharing large quantities of data in this manner.

Further, by accessing information in this manner, the user, often unwittingly, supplies information to the web server about which pages within the web site the user has accessed, and in which order. This may compromise the user's security, or the security and private data of the company for which the user works if the user is accessing the web site from a work environment.

Another method of accessing data from the Internet is via general or industry specific news organizations that offer electronic newsletters that may be received by e-mail. A user who wishes to save or archive information received in this manner has three choices for doing so: create a set of folders within an e-mail application; save the e-mail to a file on disk; or copy the information manually and paste it into a word processing document. As with information from web browsers, organizing this information is a time-consuming and error prone process.

Thus, there is a need for a tool that can be used for automating the retrieval of one or more web pages from the Internet, checking to see if the retrieved web pages contain one or more key words and, if so, extracting the text from the surrounding mark-up language and storing it locally in such a way as to facilitate its presentation, the ability to search within it, and its distribution across an organization.

### SUMMARY

In one embodiment, the present invention is directed to a method of retrieving information. The method includes obtaining a list of network sites, obtaining a list of key words to be searched for, and retrieving data from the network sites. The method also includes analyzing the data for an occurrence of any of the key words and extracting textual data from the data when a key word is found. The method further includes storing the extracted textual data in a local storage device and formatting the extracted textual data for later analysis and display.

In one embodiment, the present invention is directed an apparatus. The apparatus includes means for obtaining a list of network sites, means for obtaining a list of key words to be searched for, and means for retrieving data from the network sites. The apparatus also includes means for analyzing the data for an occurrence of any of the key words and means for extracting textual data from the data when a key word is found. The apparatus further includes means for storing the extracted textual data in a local storage device and means for formatting the extracted textual data for later analysis and display.

In one embodiment, the present invention is directed a computer readable medium having stored thereon instructions which, when executed by a processor, cause the processor to:
obtain a list of network sites;
obtain a list of key words to be searched for;
retrieve data from the network sites;
analyze the data for an occurrence of any of the key words;
extract textual data from the data when a key word is found;
store the extracted textual data in a local storage device; and
format the extracted textual data for later analysis and display.

In one embodiment, the present invention is directed a system. The system includes a processor configured to:
obtain a list of network sites;
obtain a list of key words to be searched for;
retrieve data from the network sites;
analyze the data for an occurrence of any of the key words;
extract textual data from the data when a key word is found; and
format the extracted textual data for later analysis and display; and

The system also includes a local storage device in communication with the processor, the storage device configured to store the extracted textual data.

### BRIEF DESCRIPTION OF THE FIGURES

FIG. 1 is a block diagram of a generalized computing environment suitable for retrieving, analyzing, extracting and storing textual data from a network in accordance with various embodiments of the present invention;

FIG. 2 is a flow diagram illustrating the logic for determining whether a data retrieval, extraction and storage process, a data input process, and/or a data display process should be initiated in accordance with various embodiments of the present invention;

FIG. 3 is a flow diagram illustrating the logic for retrieving URL's and key words to be searched and for initiating the retrieval process in accordance with various embodiments of the present invention;

FIG. 4 is a flow diagram illustrating the logic for retrieving one page of data from a network, searching the page for user-configured key words, extracting the text from the surrounding mark-up language in the case where a key word is found, storing the extracted textual data in that case, and, if necessary, extracting hyperlinks from the page in the form of additional URL's to be searched in accordance with various embodiments of the present invention;

FIG. 5 is a flow diagram illustrating the logic for extracting additional URL's from a retrieved page for future searches in accordance with various embodiments of the present invention;

FIG. 6 is a flow diagram illustrating the logic for inputting data concerning the URL's and key words to be searched in accordance with various embodiments of the present invention;

FIG. 7 is an example of an arrangement in which various embodiments of the present invention may be implemented;

FIG. 8 is an exemplary user interface for inputting data concerning URL's to be searched in accordance with various embodiments of the present invention;

FIG. 9 is an exemplary user interface for assigning URL's and key words to individuals or groups within an organization in accordance with various embodiments of the present invention;

FIG. 10 is a flow diagram illustrating the logic for displaying stored textual data in accordance with various embodiments of the present invention;

FIG. 11 is an exemplary user interface for editing or modifying data concerning URL's to be searched in accordance with various embodiments of the present invention;

FIG. 12 is an exemplary user interface for entering keywords according to various embodiments of the present invention;

FIG. 13 is an exemplary user interface for editing keywords that have been entered according to various embodiments of the present invention;

FIG. 14 is an exemplary status screen showing the status of the fetch node according to various embodiments of the present invention;

FIG. 15 is an exemplary user interface for displaying stored textual data in accordance with various embodiments of the present invention;

FIG. 16 is an exemplary screen showing the results of searching on the reader node according to various embodiments of the present invention; and

FIG. 17 is an exemplary screen for initiating complex searches using the reader node according to various embodiments of the present invention.

### DESCRIPTION

Various embodiments of the present invention provide methods and apparatuses for automating the search, retrieval and local storage and presentation of textual information, containing user-defined key words, from a network. In various embodiments, methods and apparatuses are provided for automating the retrieval of textual information containing user-defined key words from a network such as, for example, the Internet, either by a single user or by multiple users within, for example, an organization. The list of sites to be searched, the depth of the search within a given network site, the frequency of the search, and the key words to be searched can be configured by one or multiple users. The retrieval of the information from the network can be configured to work on one or several computers, either synchronously or asynchronously. The textual information retrieved may be extracted from any surrounding mark-up language. This information, along with information about the search, including the date and time of the search and the specific URL in which the data was found, may be stored locally where it can then be retrieved by one or multiple users. In addition to being able to retrieve the original textual information, one or multiple users may search within the locally stored data for other key words.

In various embodiments, one or multiple users may retrieve information concerning the frequency in which key words appear, for a user-defined period of time. In various embodiments, information concerning the frequency of all words retrieved may be analyzed for a user-defined period of time. In various embodiments, an Internet proxy may be configured which allows one or multiple users to have the key words highlighted in a visibly noticeable manner in, for example, a web browser.

In various embodiments, the methods and techniques described herein may be implemented as an automated electronic clipping service that can be configured to visit a list of websites on a periodic basis (e.g., daily), checking to see if the site contains any of a user-configured set of key words. If a key word is found on a website, the text is extracted from the surrounding markup language (e.g., hypertext markup language “html” or any other parsers that extract text from other markup languages such as XML, PDF, Microsoft Word® documents, etc.) and stored in a relational database (e.g., Oracle, DB2, etc). Once the text is stored in the database, it can be viewed using, for example, standard structured query language (SQL) tools. Searches can also be performed within the database (i.e., drill-down searches). Statistics can be extracted from the database about, for example, the frequency of occurrences, which can be useful for, for example, marketing or public relations purposes.

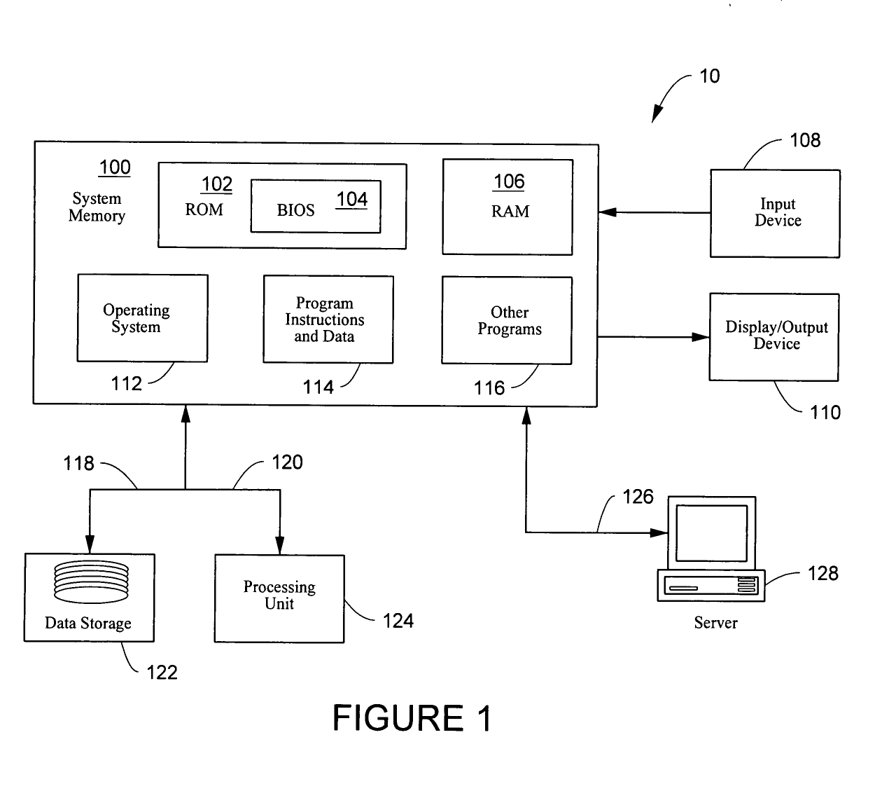

FIG. 1 is a block diagram of a generalized computing environment 10 suitable for retrieving, analyzing, extracting and storing textual data from a network in accordance with various embodiments of the present invention. The environment 10 includes a system memory 100, a processing unit 124, and non-volatile data storage 122. In various embodiments, a Basic Input/Output System (BIOS) 104, which is responsible for transferring data among different components of the system, retrieves its data on start-up from Read-Only Memory (ROM) 102. An operating system 112, which includes instructions and data 114 for executing various of the methods and techniques described herein and for executing any other programs 116 running concurrently resides in random access memory (RAM) 106 while the computing environment 10 is active.

Instructions and data are communicated via a channel 120 to the processing unit 124, and may be read from or written to the non-volatile data storage 122 through a second channel 118. In various embodiments of the present invention, program instructions and a small portion of the program data are stored on a hard disk within a personal computer, while other program data are stored in a relational database which may reside on the same hard disk, on a different hard disk, or remotely on an entirely different computer.

Various embodiments of the present invention include an input device 108 for inputting data. In various embodiments, the device 108 may be, for example, a keyboard connected via cabling directly to the system memory 100. The device 108 may be any device capable of generating alpha-numeric data and may be connected by any communications channel available to the system memory 100, including but not limited to wireless connections or remote terminals connected through, for example, a local area network (LAN) or a wide area network (WAN) such as the Internet.

Various embodiments of the present invention include a display or output device 110 for outputting the results of the program instructions 114. In various embodiments the output device 110 may be, for example, a video display terminal connected via cabling directly to the system memory 100. In various embodiments the device 110 may be a printer connected directly or via a LAN or WAN (wirelessly or not), a web-browser located on a remote computer, or a hand-held computer or personal digital assistant (PDA) connected via short or long range radio waves to the system memory 100. In various embodiments of the present invention, output data may be sent to a video terminal, a printer or a web browser.

Various embodiments of the present invention include the capability to access one or more remote servers 128 via a communications channel 126. The communications channel may be wired or wireless and may be part of, for example, a LAN or a WAN such as the Internet.

In various embodiments of the present invention, various functions of the methods and techniques described herein may be performed in a computing environment having only the requisite devices for those functions. For example, a function that requires input data may be run in an environment in which only the system memory 100, the processing unit 124, access to the non-volatile data storage 122 and the input device 108 are present. A function that requires data display or output may run in an environment where only the system memory 100, the processing unit 124, access to the non-volatile data storage 122 and the output/display device 110 are present. A function that requires access to one or more remote servers 128 may run in an environment where only the system memory 100, the processing unit 124, access to the non-volatile data storage 122 and access to one or more remote servers 128 are present. In various embodiments, in an environment where all of the aforementioned components are present, all three types of aforementioned functions may be run.

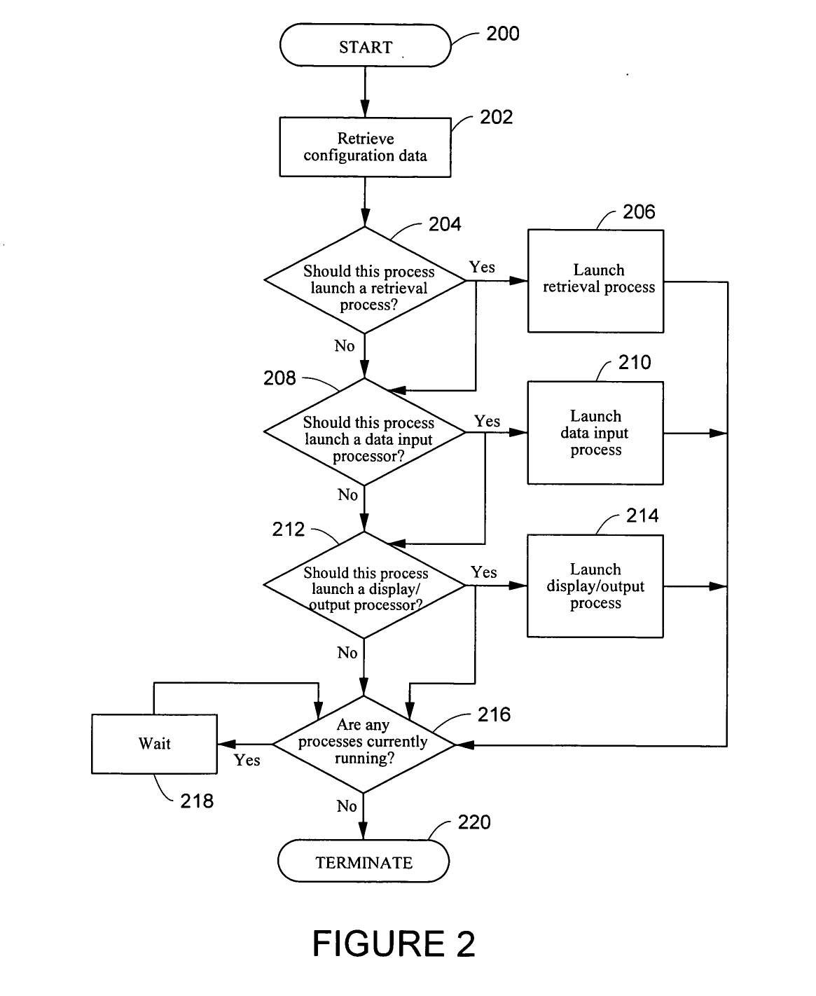

FIG. 2 is a flow diagram illustrating the logic for determining whether a data retrieval, extraction and storage process, a data input process, and/or a data display process should be initiated in accordance with various embodiments of the present invention. The process begins at block 200 and proceeds to block 202 where configuration data are retrieved from the non-volatile data storage 122 to be used to determine the results of the tests in blocks 204, 208, and 212. The process then proceeds to block 204 where a test is made to determine whether the process should launch a retrieval process to retrieve pages from a network such as the Internet.

If in block 204 it is determined that the process should launch a retrieval process, the process proceeds to block 206 where a retrieval process is launched. Without waiting for the retrieval process to return, block 204 proceeds to block 208 where another test is performed. If in block 204 it is determined that the process should not launch a retrieval process, the process proceeds directly to block 208. In block 208 a test is performed to determine whether the process should launch a data input process. If in block 208 it is determined that the process should launch a data input process, the process proceeds to block 210 where a data input process is launched. Without waiting for the process of block 210 to return, the process proceeds to block 212.

If in block 208 it is determined that the process should not launch a data input process, the process proceeds directly to block 212 where another test is performed. In block 212 a test is performed to determine whether the process should launch a data output or display process. If in block 212 it is determined that the process should launch a data output or display process, the process proceeds to block 214 where a data output/display process is launched. Without waiting for the process of block 214 to return, the process also proceeds to block 216. If in block 214 it is determined that a data output/display process should not be launched, the process proceeds directly to block 216. In block 216 a test is made to determine if any of the processes which may have been launched in blocks 206, 210 and/or 214 are still running.

If in block 216 it is determined that there are still processes running, the process proceeds to block 218 and waits for a specified time after which the process proceeds back to block 216 where the test is repeated. If in block 216 it is determined that there are no more launched processes running, the process terminates at block 220.

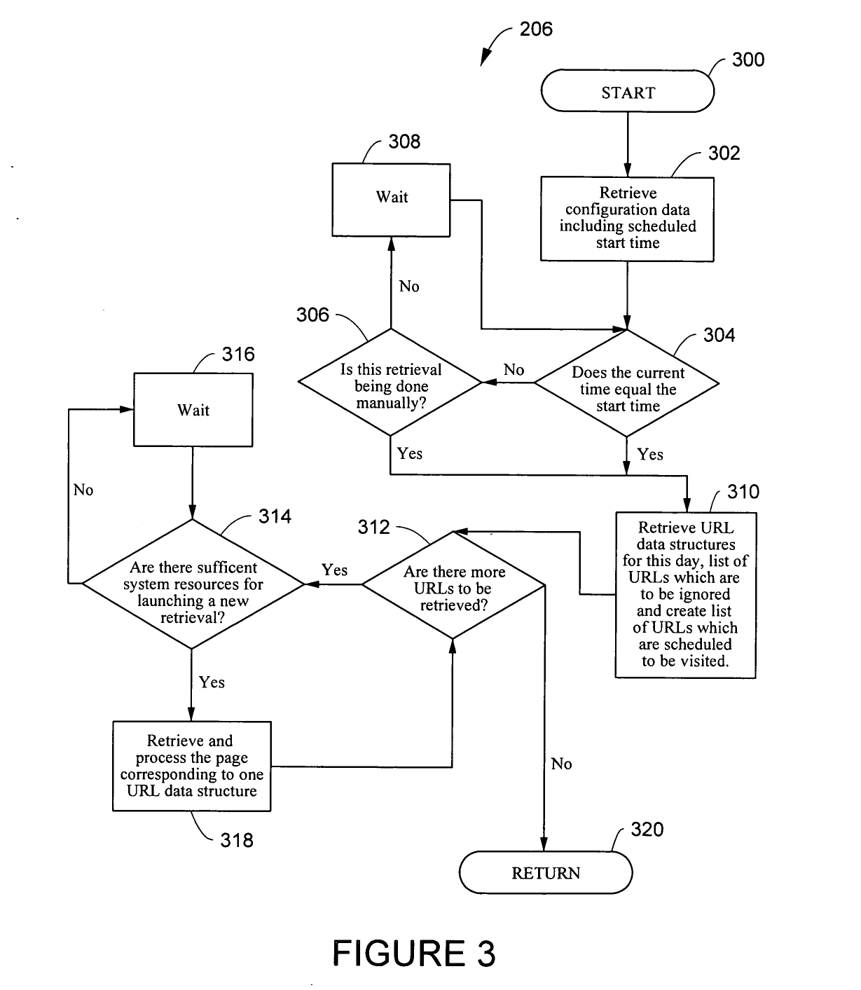

FIG. 3 is a flow diagram illustrating the logic for retrieving URL's and key words to be searched and for initiating the retrieval process 206 of FIG. 2 in accordance with various embodiments of the present invention. The process begins at block 300 and proceeds to block 302 where the process retrieves configuration data from the non-volatile data storage 122. The configuration data includes information about the time at which the next retrieval operation is scheduled to start. The process then proceeds to block 304 where a test is made to determine whether the current system time as retrieved from the system memory 100 is equal to the scheduled start time.

If in block 304 it is determined that the current time is equal to the scheduled start time, the process proceeds to block 310. If in block 304 it is determined that the current time is not equal to the scheduled start time, the process proceeds to block 306 where a test is made to determine whether the retrieval is being run manually and thus should begin regardless of the scheduled start time. If in block 306 it is determined that the retrieval process is being run manually and should begin regardless of the scheduled start time, the process proceeds to block 310. If in block 306 it is determined that the retrieval process is not being run manually, the process proceeds to block 308 where the process waits a specified time. The process then proceeds back to block 304.

In block 310 the process retrieves data and data structures from the non-volatile data storage 122. The data and data structures concern the URL's which should form the basis of the retrieval and the key words which should be searched for once the page referenced by the URL has been retrieved. In various embodiments of the present invention, the data structure includes information on the starting URL, on the depth to which hyperlinks from the URL should be followed, on whether hyperlinks should be followed if they are outside the domain of the starting URL, on whether the URL requires authentication, the authentication information necessary if required, and the key words which should be searched for within the URL and any pages which are linked to it. In block 310, the process also creates a master list of all the URL's which are scheduled to be visited in order to avoid having the process repeatedly retrieve the same page.

The process then proceeds to block 312 where a test is made to determine whether there are any URL's to retrieve. If in block 312 it is determined that there are one or more URL's to retrieve, the process proceeds to block 314 where a test is made to determine whether there are sufficient system resources available to start the process of retrieving one URL. Available system resources may include, for example, the speed of the processing unit 124, the amount of available RAM 106, the size of the communications channel 126 for accessing remote servers 128 and the number of other processes that may be running concurrently within the computing environment 10. If in block 314 it is determined that there are sufficient resources for retrieving one URL, the process proceeds to block 318 where the process for retrieving the page corresponding to one URL is launched. Without waiting for the process of block 318 to return, the process proceeds to block 312 where the test to determine whether there exist more URL's to retrieve is repeated.

If in block 314 it is determined that there do not exist sufficient system resources to launch a retrieval process, the process proceeds to block 316 where the process waits a specified time, after which the process returns to block 314 where the test to determine whether there are sufficient system resources is repeated. If in block 312 it is determined that there are no more URL's to be retrieved, the process proceeds to block 320 where the process returns.

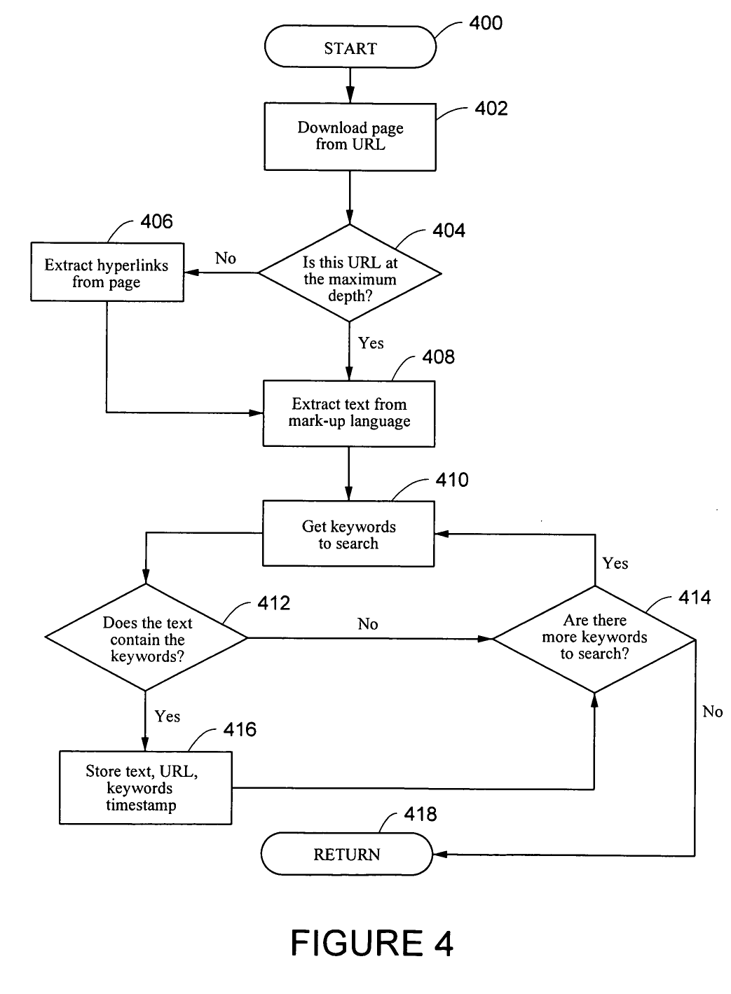

FIG. 4 is a flow diagram illustrating the logic for retrieving one page of data from a network at block 318 of FIG. 3, searching the page for user-configured key words, extracting the text from the surrounding mark-up language in the case where a key word is found, storing the extracted textual data in that case, and, if necessary, extracting hyperlinks from the page in the form of additional URL's to be searched in accordance with various embodiments of the present invention. The process begins at block 400 and proceeds to block 402 where the process requests a file from the remote server 128 at the URL given by block 318 of FIG. 3. The process then stores the file locally in the system memory 100. The process then proceeds to block 404 where a test is made to determine whether the current URL is at its maximum depth in relation to the URL used to initiate the search. If in decision block 404 it is determined that the URL is at its maximum depth, the process proceeds to block 408 where the text of the downloaded file is extracted from the surrounding mark-up language. If in decision block 404 it is determined that the URL is at not at its maximum depth, the process proceeds to block 406 where hypertext links are extracted from the downloaded page. When the process returns from block 406, the process proceeds to block 408.

From block 408 the process proceeds to block 410 where the list of key words to be searched within the extracted text is retrieved. The process then proceeds to block 412 where a test is made to determine whether the extracted text contains a key word from the list in block 410. If in block 412 it is determined that the extracted text does contain the key word, the process proceeds to block 416 where the extracted text is stored in the non-volatile data storage 122 along with the current URL which was downloaded, the key word which was found and the date and time at which the page was retrieved. The process then proceeds to block 414. If in block 412 it is determined that the extracted text does not contain the key word, the process proceeds to block 414. In block 414 a test is made to determine whether there exists more key words on the list to be searched. If in block 414 it is determined that there are more key words to be searched, the process proceeds back to block 410 where another key word is retrieved from the list. If in block 414 it is determined that there are no more key words to search for within the extracted text, the process proceeds to block 418 where the process returns.

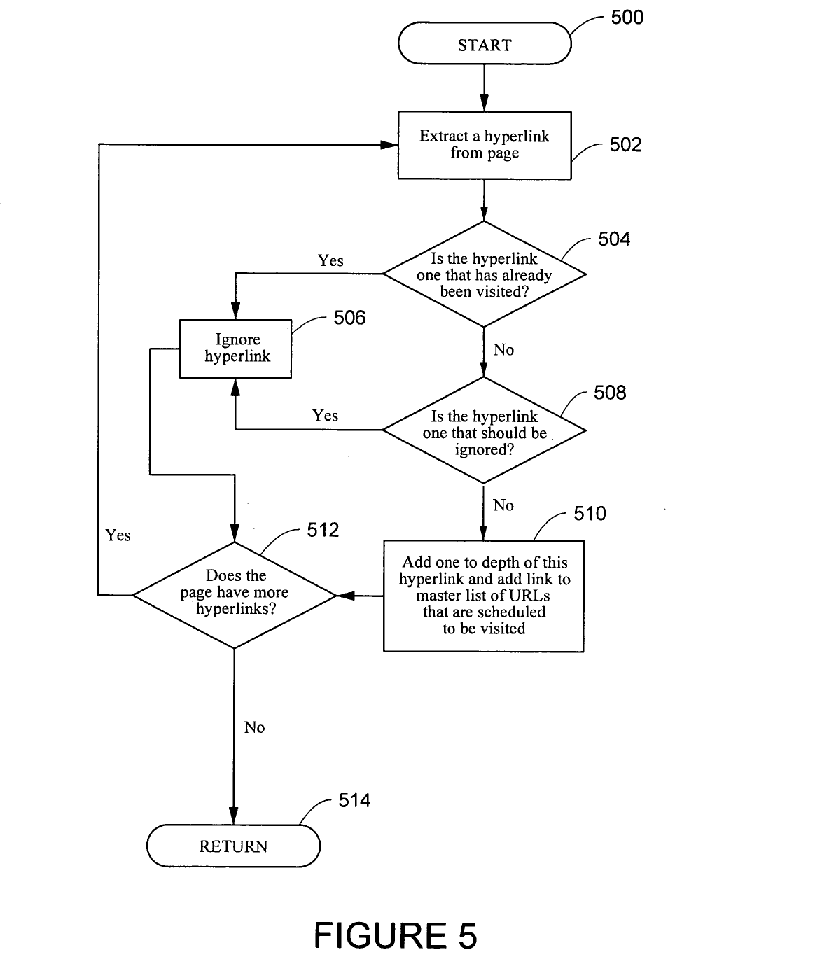

FIG. 5 is a flow diagram illustrating the logic for extracting additional URL's from a retrieved page for future searches at block 406 of FIG. 4 in accordance with various embodiments of the present invention. The process begins at block 500 and then proceeds to block 502 where a hyperlink is extracted from the page. The process then proceeds to block 504 where the hyperlink is compared with the master list of links scheduled to be visited (block 310 of FIG. 3). If the hyperlink has already been visited or is scheduled to be visited, the process proceeds to block 506 where the hyperlink is ignored. The process then proceeds to block 512 where a test is made to determine whether the page contains any more hyperlinks. If in block 512 it is determined that the page does contain more hyperlinks, the process returns to block 502 where the next hyperlink on the page is extracted.

If in block 504 it is determined that the extracted hyperlink has not already been visited or is not scheduled to be visited, the process proceeds to block 508 where the hyperlink is compared to the list of URL's which should be ignored (block 310 of FIG. 3). If in block 508 it is determined that the hyperlink should be ignored, the process proceeds to block 506 where the hyperlink is ignored. If in block 508 it is determined that the hyperlink should not be ignored, the process proceeds to block 510 where information within the data structure for the hyperlink concerning its current depth is increased by one in relation to the URL which was downloaded, and the hyperlink is added to the master list of URL's scheduled to be visited (block 310 of FIG. 3). The process then proceeds to block 512 where a test is again made to determine whether the downloaded page contains any more hyperlinks. If in block 512 it is determined that the downloaded page contains more hyperlinks, the process proceeds to block 502 where the process of extracting the next hyperlink on the page is executed. If in block 512 it is determined that the page does not contain any more hyperlinks, the process proceeds to block 514 where the process returns.

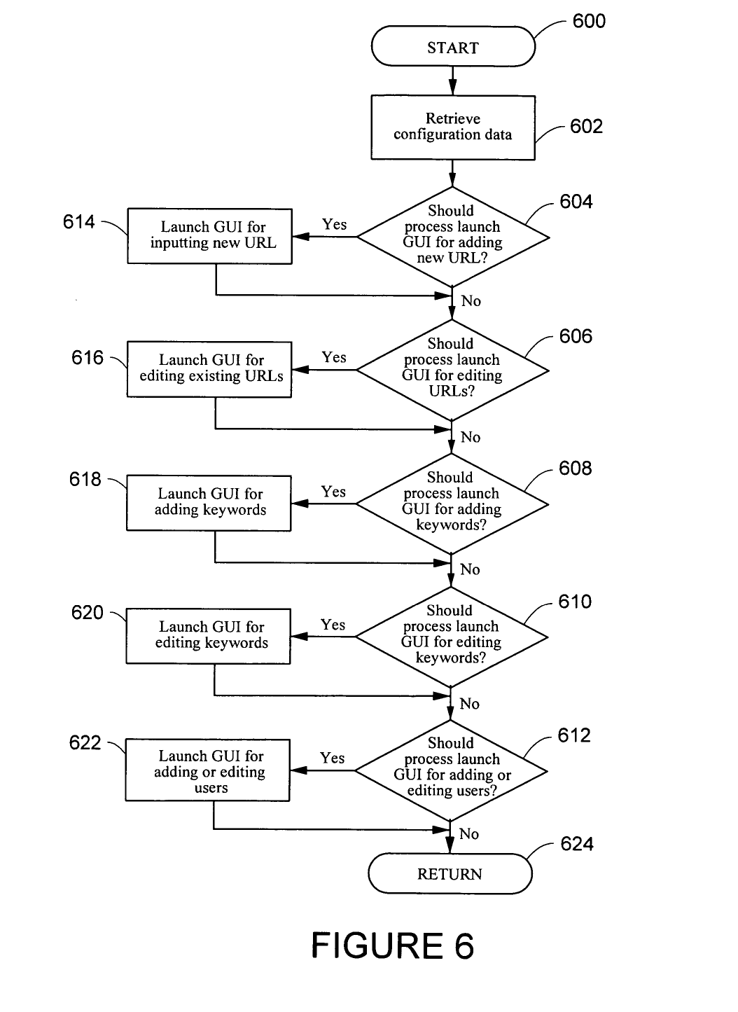

FIG. 6 is a flow diagram illustrating the logic for inputting data concerning the URL's and key words to be searched from block 210 in FIG. 2 in accordance with various embodiments of the present invention. The process begins in block 600 and then proceeds to block 602 where configuration data is read from non-volatile data storage 122. The process then proceeds to block 604 where a test is made to determine whether a graphical user interface (GUI) for inputting or adding new URL's should be presented to the user. If in block 604 it is determined that a graphical user interface for adding or inputting new URL's should be presented, the process proceeds to block 614 where a graphical user interface for adding new URL's is presented.

If in block 604 it is determined that a graphical user interface for adding or inputting new URL's should not be presented, the process proceeds to block 606 where a test is made to determine whether a graphical user interface for editing URL's should be presented. If in block 606 it is determined that a graphical user interface for editing existing URL's should be presented, the process proceeds to block 616 where a graphical user interface for editing existing URL's is presented.

If in block 606 it is determined that a graphical user interface for editing existing URL's should not be presented, the process proceeds to block 608 where a test is made to determine whether a graphical user interface should be presented for adding new key words. If in block 608 it is determined that a graphical user interface for adding new key words should be presented, the process proceeds to block 618 where a graphical user interface for adding new key words is presented. If in block 608 it is determined that a graphical user interface for adding new key words should not be presented, the process proceeds to bock 610 where a test is made to determine whether a graphical user interface for editing existing key words should be presented. If in block 610 it is determined that a graphical user interface for editing existing key words should be presented, the process proceeds to block 620 where a graphical user interface for editing existing key words is presented. If in block 610 it is determined that a graphical user interface for editing existing key words should not be presented, the process proceeds to block 612 where a test is made to determine whether a graphical user interface for adding and editing users should be presented. If in block 612 it is determined that a graphical user interface for adding and editing users should be presented, the process proceeds to block 622 where a graphical user interface for adding or editing users is presented.

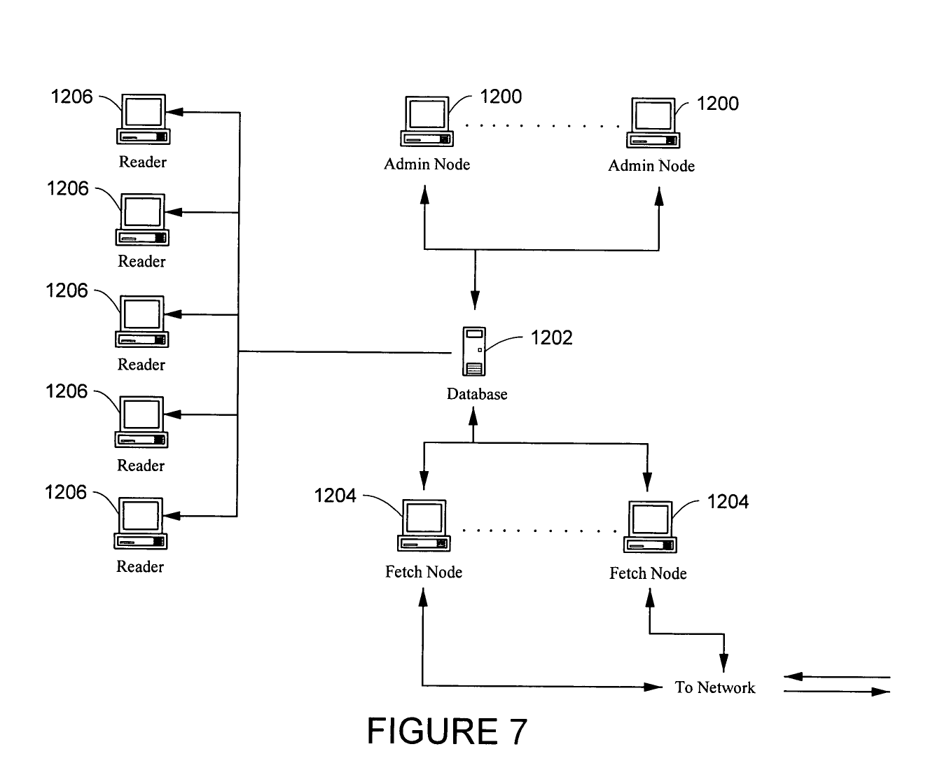

FIG. 7 is an example of an arrangement in which various embodiments of the present invention may be implemented. Admin nodes 1200 are in communication with a database 1202. Fetch nodes 1204 are also in communication with the database 1202 and a network such as the Internet (not shown). Reader nodes 1206 are in communication with the database 1202. In operation and according to various embodiments, search criteria are entered into the database 1202 using the admin nodes 1200. The fetch nodes 1204 are then configured to retrieve the search criteria from the database 1202 at, for example, specified intervals, and perform the search. The reader nodes 1206 are used to access the data that has been retrieved.

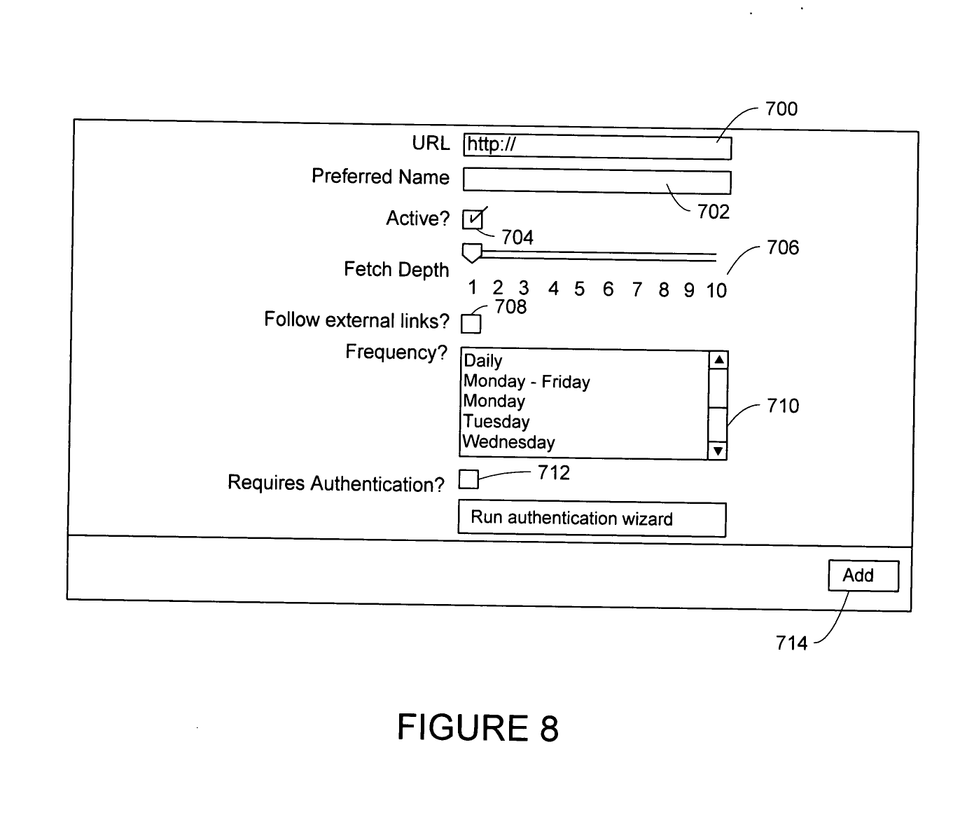

FIG. 8 is an exemplary user interface for inputting data, by the admin nodes 1200, concerning URL's to be searched in accordance with various embodiments of the present invention. A text input box 700 is for typing in the URL which is to be added and from which the fetch node 1204 will begin. A text box 702 is for entering an alternative or preferred name for the URL entered in the box 700 which will be displayed by the reader node 1206. A check box 704 is for inputting whether the URL should be active and thus searched by the fetch node 1204. An interface 706 is for inputting the depths to which hyperlinks in the URL should be followed by the fetch node 1204. A check box 708 is for inputting data as to whether hyperlinks in the URL should be followed by the fetch node 1204 if they point to URL's which are outside the domain of the URL. An interface 710 is for inputting data on the frequency with which the URL should be searched by the fetch node 1204. A check box 712 is for inputting data on whether the URL requires some form of authentication in order to download the corresponding page. A button 704 is for storing all of the previous information in non-volatile data storage 122.

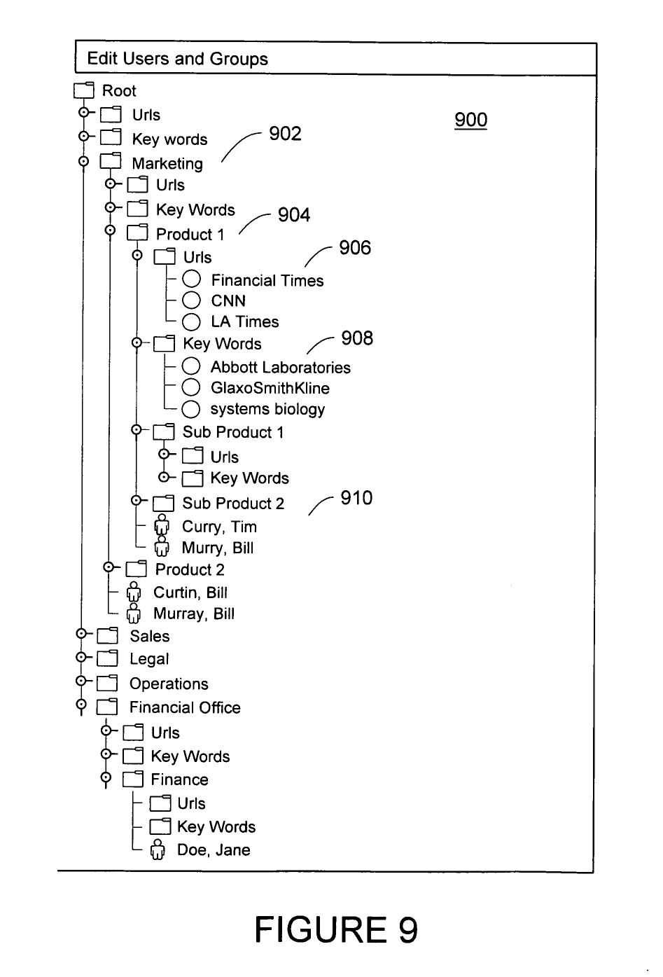

FIG. 9 is an exemplary user interface 900 for assigning URL's and key words to individuals or groups within an organization in accordance with various embodiments of the present invention. The interface 900 is hierarchical and may be used by the admin nodes 1200 for adding and editing users. A node 902 in the hierarchical interface 900 may represent a specific department within an organization. A node 904 in the hierarchical interface may be a sub-division within the department represented in node 902. URL's 906 are those which have been assigned to the sub-division of the department as represented by node 904. Key words 908 are those key words which have been assigned to the sub-division of the department as represented by node 904. Users 910 are those users who might be assigned to the department represented in node 902. The user may edit any of the nodes of the interface 900 or add new nodes by clicking on them.

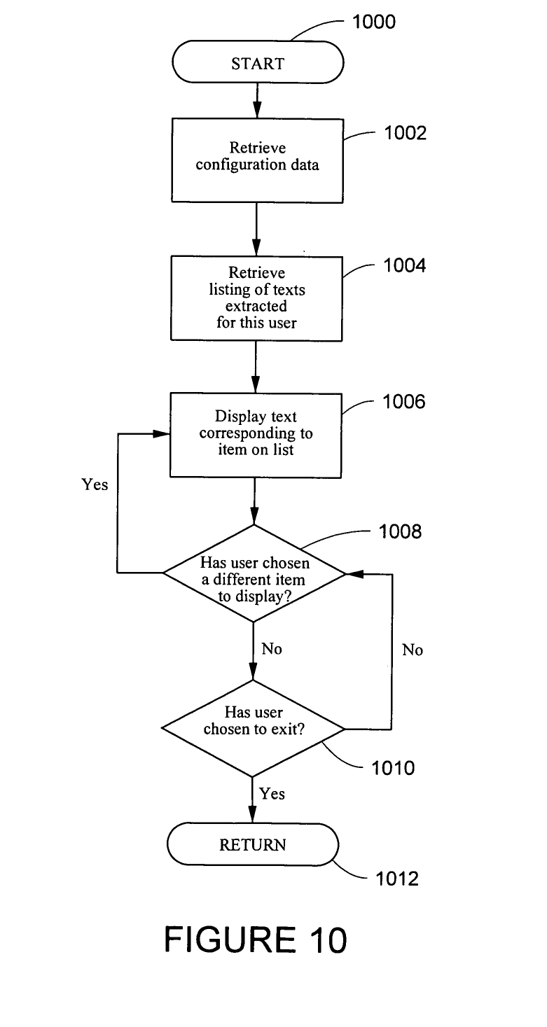

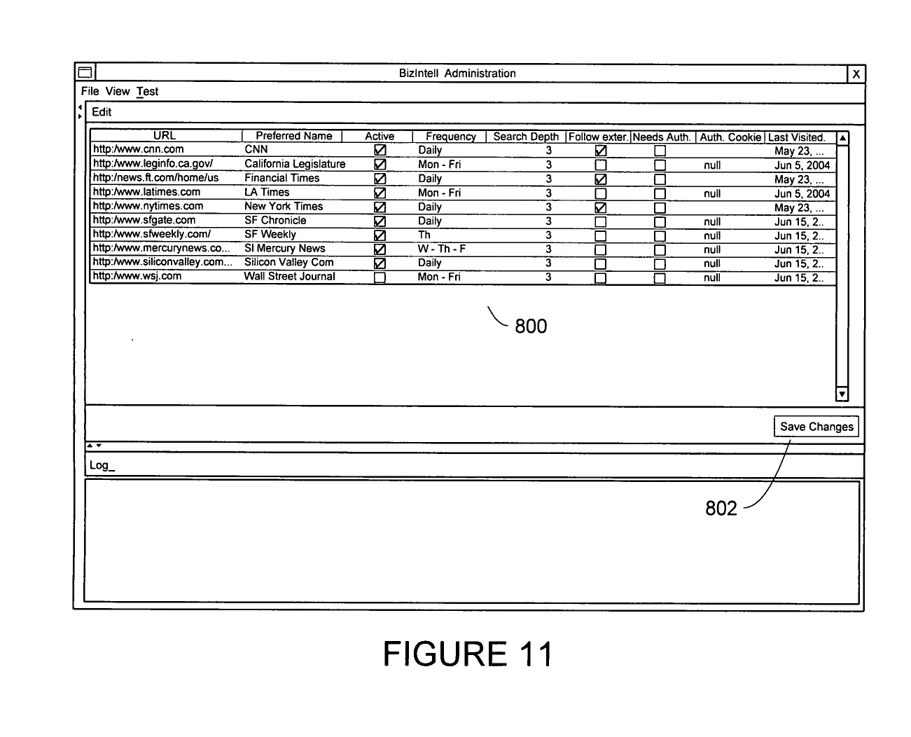

FIG. 10 is a flow diagram illustrating the logic for displaying stored textual data of block 214 in FIG. 2 in accordance with various embodiments of the present invention. The process begins at block 1000 and proceeds to block 1002 where the configuration data is read from the non-volatile storage 122. The process proceeds to block 1004 where the appropriate list of texts is retrieved from the non-volatile data storage 122 according to the configuration data from block 1002. In various embodiments, the list of texts is presented to the user in a graphical user interface as illustrated hereinbelow in conjunction with FIG. 11.

From block 1004 the process proceeds to block 1006 where textual data corresponding to one item on the list from block 1002 is displayed. The process then proceeds to block 1008 where a test is made to determine whether a different piece of textual data should be displayed. If in block 1008 it is determined that a different piece of textual data should be displayed, the process proceeds to block 1006 where the different piece of textual data is displayed. If in block 1008 it is determined that a different piece of textual data should not be displayed, the process proceeds to block 1010 where a test is made to determine whether the process should be terminated. If in block 1010 it is determined that the process should terminate, the process proceeds to block 1012 where the process terminates and returns. If in block 1010 it is determined that the process should not terminate, the process proceeds back to block 1008 where the first test is repeated.

FIG. 11 is an exemplary user interface for editing or modifying data, by the admin node 1200, concerning URL's to be searched in accordance with various embodiments of the present invention. A table 800 lists all of the URL's, and the information concerning them, which have been added using the interface of FIG. 7. A user may edit the information contained in any cell of the table 800 by clicking on it and editing the information. A button 802 is presented which allows the user to store in the non-volatile data storage 122 any changes which have been made.

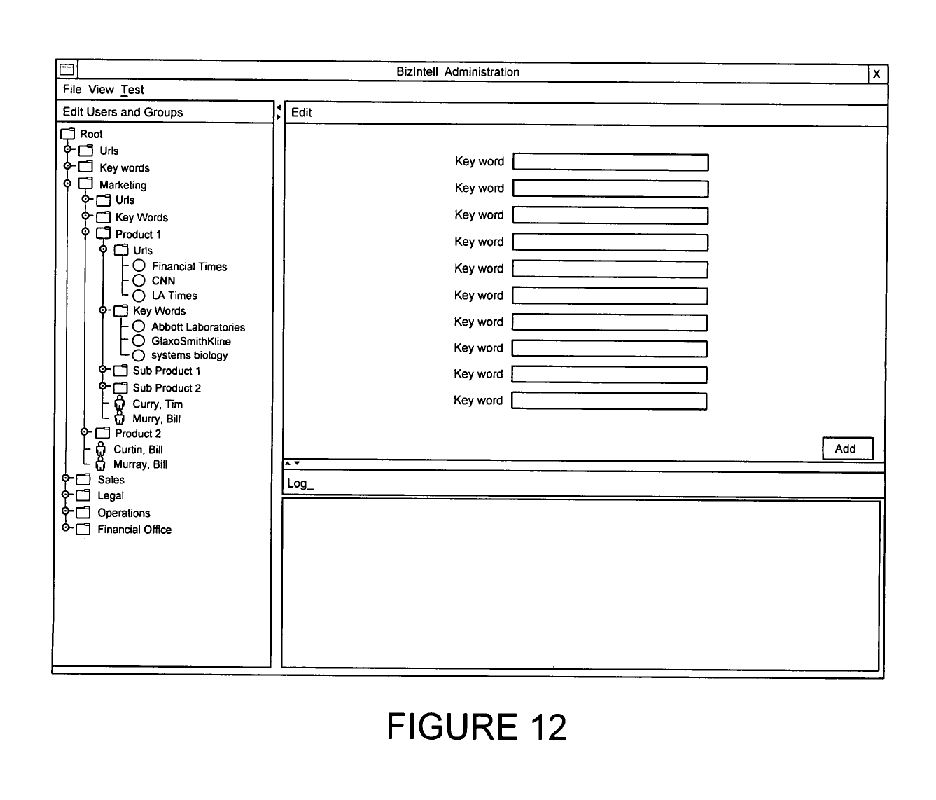

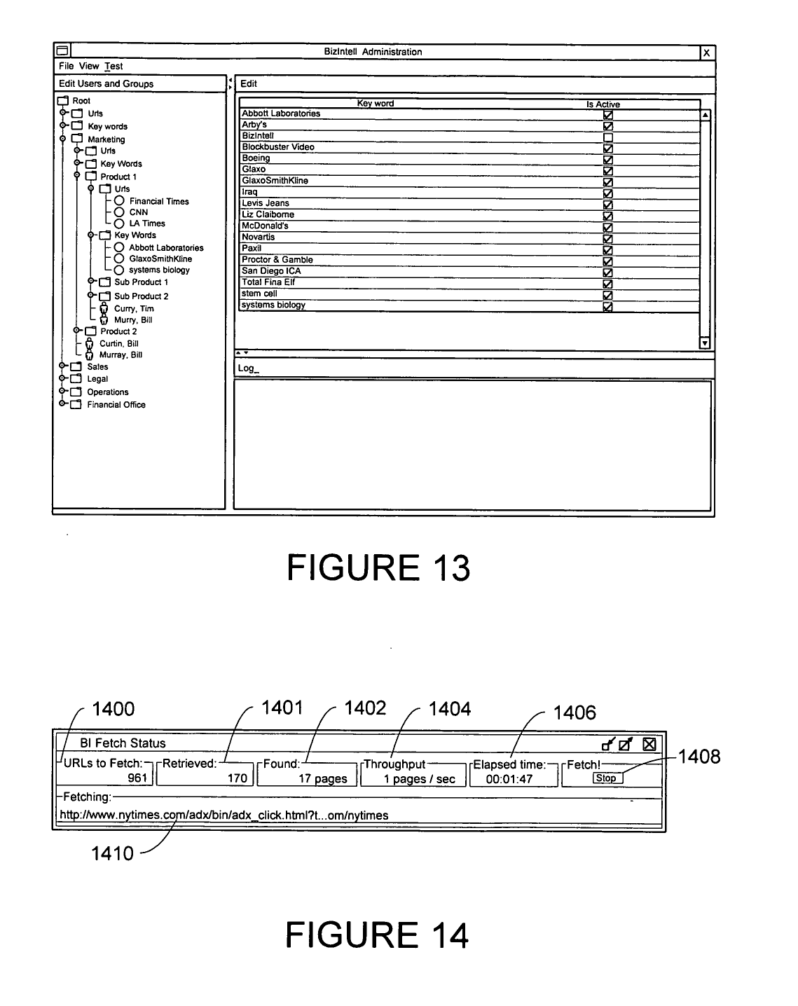

FIG. 12 is an exemplary user interface for entering, by the admin node 1200, keywords according to various embodiments of the present invention. FIG. 13 is an exemplary user interface for editing keywords that have been entered according to various embodiments of the present invention. FIG. 14 is an exemplary status screen showing the status of the fetch node 1204 according to various embodiments of the present invention. The status screen shows the number of URL's which are currently on the list to be searched 1400, the number of pages that have already been downloaded 1401, the number of pages in which key words have been found 1402 and the extracted text stored in the database 1202, the throughput 1404, the elapsed time 1406 of the fetch process, a stop button 1408, and the URL which is currently being downloaded 1410.

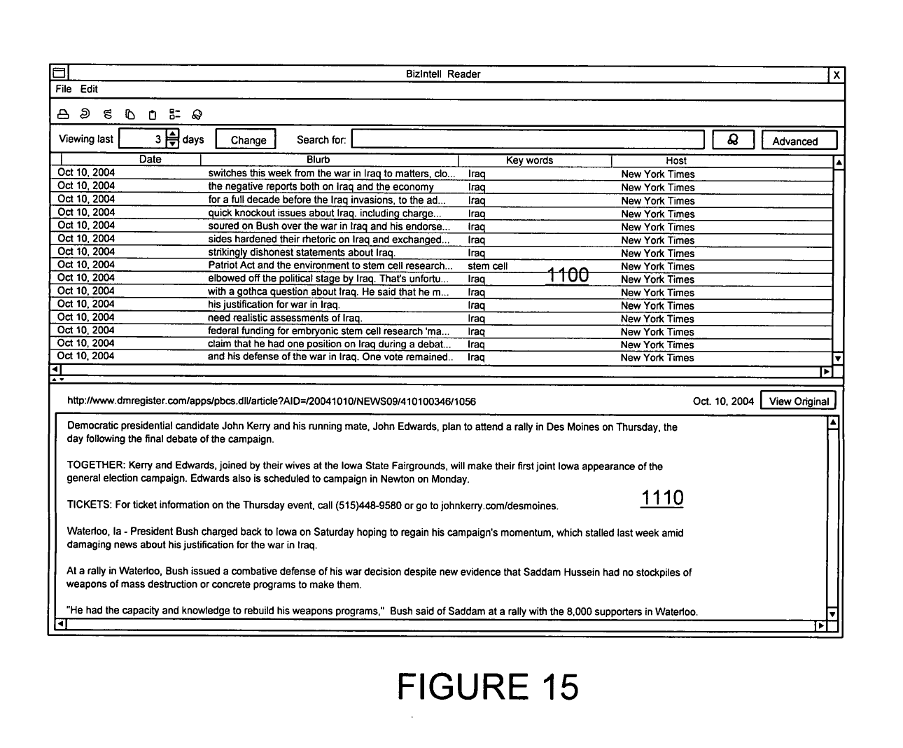

FIG. 15 is an exemplary user interface for displaying stored textual data at the reader node 1206 in accordance with various embodiments of the present invention. A listing 1100 of the pieces of textual data is a listing of the data which are available for the user. A piece of textual data 1110 corresponds to a choice made in the listing 1100. The user may change the textual data 1110 displayed by clicking on a different item in the list 1100. In various embodiments, other interfaces for outputting data are possible, including, but not limited to interfaces for web browsers, personal digital assistants (PDAs), printers, televisions, etc.

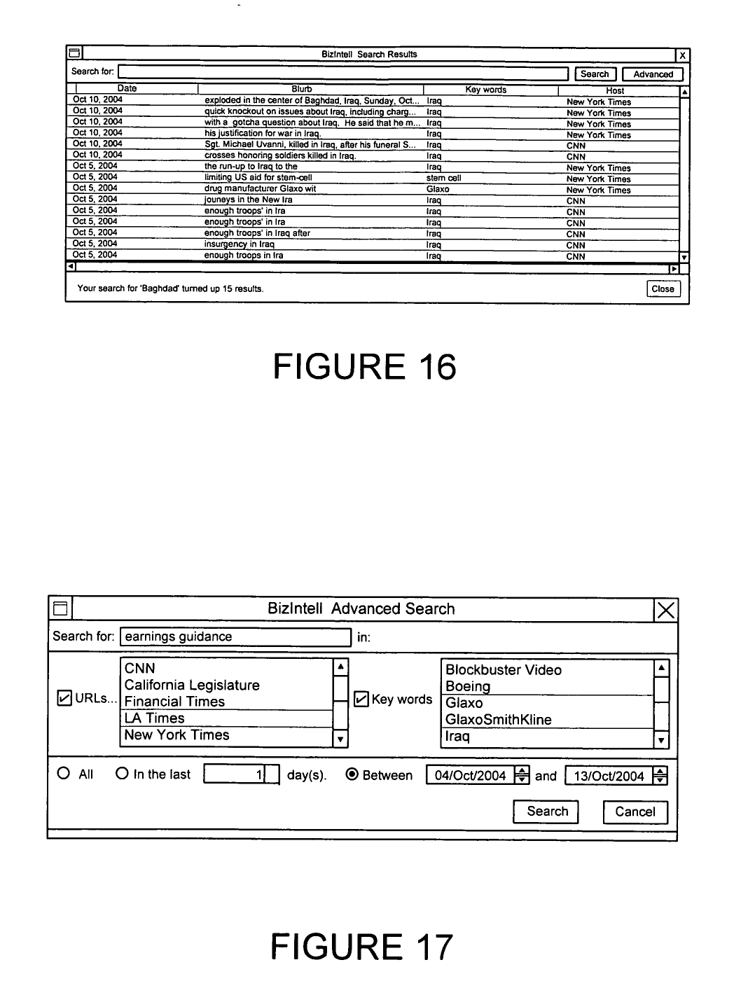

FIG. 16 is an exemplary screen showing the results of searching on the reader node 1206 according to various embodiments of the present invention. FIG. 17 is an exemplary screen for initiating complex searches using the reader node 1206 according to various embodiments of the present invention.

Various embodiments of the present invention may be used for various purposes within an organization. For example, a person who is responsible for representing the organization and defining its survival and growth strategies (e.g., a CEO of a company) might utilize the techniques described herein to visit industry specific web sites, local newspapers in areas in which the organization does business, competitors' websites, social and environmental activist sites, etc., in search of key words concerning the organization's current and future growth strategies, possible shifts in the business environment, etc. Also, a person who is responsible for managing investments (e.g., a CFO of a company) might utilize the techniques described herein to track news of investments, to gather information concerning potential take-over targets, etc.

A person who is responsible for the day to day financial management of an organization (e.g., a treasurer) might utilize the techniques described herein to keep track of news concerning clients and their ability to repay any debts to the organization. This information could be used to change the amount or terms of credit extended to a client, etc. The legal department of an organization could utilize the techniques described herein to visit a state or local government website to search for legislation that might be introduced and which might have an effect on the business climate or competitiveness of the organization, at a greatly reduced cost compared to hiring lawyers or lobbyists to do that for them.

A marketing department in an organization could utilize the techniques described herein to follow trends in specific market segments by visiting websites frequented by the segment and searching for mentions of the organization's or competitors' products. The marketing department could also utilize the techniques described herein to measure the change over time of the frequency of mentions in response to marketing activities. A public relations entity could utilize the techniques described herein to visit specific news or other sites for mentions of an organization's products and officers. The public relations entity could also utilize the techniques described herein to measure the change over time of the frequency of mentions in response to communications activities.

A sales department of an organization could utilize the techniques described herein to keep track of the sales prices and discounts of competitors in order to react more quickly to changes. An operations entity could utilize the techniques described herein to keep track of changes within an industry and the industry's modes of production. The operations entity could also utilize the techniques described herein to search for news of suppliers and their continued ability to furnish the necessary goods at the agreed upon time.

The term “computer-readable medium” is defined herein as understood by those skilled in the art. It can be appreciated, for example, that method steps described herein may be performed, in certain embodiments, using instructions stored on a computer-readable medium or media that direct a computer system to perform the method steps. A computer-readable medium can include, for example and without limitation, memory devices such as diskettes, compact discs of both read-only and writeable varieties, digital versatile discs (DVD), optical disk drives, and hard disk drives. A computer-readable medium can also include memory storage that can be physical, virtual, permanent, temporary, semi-permanent and/or semi-temporary. A computer-readable medium can further include one or more data signals transmitted on one or more carrier waves.

As used herein, a “computer” or “computer system” may be, for example and without limitation, either alone or in combination, a personal computer (PC), server-based computer, main frame, microcomputer, minicomputer, laptop, personal data assistant (PDA), cellular phone, pager, processor, including wireless and/or wireline varieties thereof, and/or any other computerized device capable of configuration for processing data for either standalone application or over a networked medium or media. Computers and computer systems disclosed herein can include memory for storing certain software applications used in obtaining, processing, storing and/or communicating data. It can be appreciated that such memory can be internal or external, remote or local, with respect to its operatively associated computer or computer system. The memory can also include any means for storing software, including a hard disk, an optical disk, floppy disk, ROM (read only memory), RAM (random access memory), PROM (programmable ROM), EEPROM (extended erasable PROM), and other suitable computer-readable media.

It is to be understood that the figures and descriptions of embodiments of the present invention have been simplified to illustrate elements that are relevant for a clear understanding of the present invention, while eliminating, for purposes of clarity, other elements. Those of ordinary skill in the art will recognize, however, that these and other elements may be desirable for practice of various aspects of the present embodiments. However, because such elements are well known in the art, and because they do not facilitate a better understanding of the present invention, a discussion of such elements is not provided herein. It can be appreciated that, in some embodiments of the present methods and systems disclosed herein, a single component can be replaced by multiple components, and multiple components replaced by a single component, to perform a given function or functions. Except where such substitution would not be operative to practice the present methods and systems, such substitution is within the scope of the present invention. Examples presented herein, including operational examples, are intended to illustrate potential implementations of the present method and system embodiments. It can be appreciated that such examples are intended primarily for purposes of illustration. No particular aspect or aspects of the example method, product, computer-readable media, and/or system embodiments described herein are intended to limit the scope of the present invention.

It should be appreciated that figures presented herein are intended for illustrative purposes and are not intended as construction drawings. Omitted details and modifications or alternative embodiments are within the purview of persons of ordinary skill in the art. Furthermore, whereas particular embodiments of the invention have been described herein for the purpose of illustrating the invention and not for the purpose of limiting the same, it will be appreciated by those of ordinary skill in the art that numerous variations of the details, materials and arrangement of parts/elements/steps/functions may be made within the principle and scope of the invention without departing from the invention as described in the appended claims.

What is claimed is:

1. A method of retrieving information, the method comprising:
obtaining a list of network sites;
obtaining a list of key words to be searched for;
retrieving data from the network sites;
analyzing the data for an occurrence of any of the key words;
extracting textual data from the data when a key word is found;
storing the extracted textual data in a local storage device; and
formatting the extracted textual data for later analysis and display.

2. The method of claim 1, wherein extracting textual data includes extracting textual data from any surrounding mark-up language.

3. The method of claim 1, further comprising retrieving a hyperlink from the data.

4. The method of claim 3, further comprising permitting a user to specify a depth to which the hyperlink and successive hyperlinks are retrieved.

5. The method of claim 3, further comprising permitting a user to specify whether the hyperlink should be followed if it lies outside a domain.

6. The method of claim 3, further comprising permitting a user to specify whether the hyperlink requires authentication.

7. The method of claim 3, further comprising assigning the hyperlink and a key word to one of an individual and an entity.

8. The method of claim 1, further comprising displaying textual data corresponding to the key word and a hyperlink only to users who are permitted to see the textual data corresponding to the key word and the hyperlink.

9. The method of claim 1, further comprising permitting a user to input the network sites and the key words using a graphical user interface.

10. The method of claim 1, further comprising displaying the textual data using a graphical user interface.

11. The method of claim 1, further comprising displaying information concerning a current state of a retrieval process using a graphical user interface.

12. An apparatus, comprising:
means for obtaining a list of network sites;
means for obtaining a list of key words to be searched for;
means for retrieving data from the network sites;
means for analyzing the data for an occurrence of any of the key words;
means for extracting textual data from the data when a key word is found;
means for storing the extracted textual data in a local storage device; and
means for formatting the extracted textual data for later analysis and display.

13. A computer readable medium having stored thereon instructions which, when executed by a processor, cause the processor to:
obtain a list of network sites;
obtain a list of key words to be searched for;
retrieve data from the network sites;
analyze the data for an occurrence of any of the key words;
extract textual data from the data when a key word is found;
store the extracted textual data in a local storage device; and
format the extracted textual data for later analysis and display.

14. A system, comprising:
a processor configured to:
obtain a list of network sites;
obtain a list of key words to be searched for;
retrieve data from the network sites;
analyze the data for an occurrence of any of the key words;
extract textual data from the data when a key word is found; and
format the extracted textual data for later analysis and display; and
a local storage device in communication with the processor, the storage device configured to store the extracted textual data.
